(19) United States
(12) Patent Application Publication
(10) Pub. No.: US 2014/0267736 A1
(43) Pub. Date: Sep. 18, 2014

(54) VISION BASED SYSTEM FOR DETECTING A BREACH OF SECURITY IN A MONITORED LOCATION

(71) Applicant: Bruno DeLean, Andorra La Vella (ID)

(72) Inventor: Bruno DeLean, Andorra La Vella (ID)

(21) Appl. No.: 14/160,886

(22) Filed: Jan. 22, 2014

Related U.S. Application Data
(63) Continuation-in-part of application No. 13/837,689, filed on Mar. 15, 2013.

(51) Int. Cl. H04N 7/18

(52) U.S. Cl. CPC H04N 7/183
USPC 348/152

(57) ABSTRACT

Vision based system and method for detecting a breach of security in a monitored area. One or more sequences of events are stored in the system. Each sequence of events includes a different combination of events and an order in which the events have occurred. An action is associated with each sequence of events such as triggering an alarm, generating an audible sound, calling 911 etc. when the events detected by the system match a given sequence the action associated with that sequence is performed. The system receives an image stream of the area and detects the events occurring in the images including the detection of a human body, its size and location within the monitored area. The system may be activated at all time without requiring people in the monitored area to change their normal behavior.

### CROSS REFERENCE TO RELATED APPLICATIONS

This application claims priority from U.S. patent application Ser. No. 13/837,689 filed on Mar. 15, 2013 and entitled “Authenticating A User Using Hand Gesture”, the specification of which is hereby incorporated by reference in its entirety.

### BACKGROUND

(a) Field

The subject matter disclosed generally relates to vision based security systems.

(b) Related Prior Art

Conventional systems and methods for detecting the crossing of predefined perimeter have a physical presence which makes them easy to disable and overcome.

For example, there are contact switches in the market which may be installed at the door hinge for detecting the opening of the door. However, an intruder my simply disable the switch, or make an opening in the door and go through it without activating the switch.

Another type of sensors includes the wave based sensors which emit waves and receive their feedback to detect a movement or appearance of an object in the monitored area when a certain wave is received faster than the usual. However, there are methods for disabling and/or overcoming this type of sensors. A simple example would be to pass through the monitored area between the different beams without interrupting them.

Furthermore, these systems do not allow for a sophisticated analysis of the movement. In other words, they do not distinguish between a movement (or a series of movements) that defines a breach of security and another which does not. For example, once activated these systems do not differentiate between a person leaving the monitored area and a person entering that area.

Therefore, there is a need in the market for an improved security system and method for detecting a breach of security in a monitored area.

### SUMMARY

The present embodiments describe such system and method.

In an aspect, there is provided a vision based computer-implemented method for detecting a breach of security in a monitored location, the method comprising: storing a succession of events defining the breach of security and an action to be performed in response to detecting the breach of security, said succession of events comprising two or more events and a predetermined sequence in which said events are performed. The method also comprises receiving a stream of images of said location from an image capturing device; defining at least a first zone and a second zone within said images; detecting a first sequence of events matching the predetermined sequence in said images, including: detecting a first event in the first zone and detecting a second event in the second zone; wherein at least one of the first event and the second event represent detection of a first human body in a corresponding zone. The method further comprises performing the action associated with the breach of security, in response to detecting the first sequence.

In an embodiment, the first event represents detection of the first source of activity in the first zone and the second event represents detection of the first source of activity in the second zone, wherein the first sequence comprises detecting the first event prior to detecting the second event.

In another embodiment, the first event represents detection of the first source of activity in the first zone and the second event represents detection of the first source of activity in the second zone, wherein the first sequence comprises detecting the second event prior to detecting the first event.

In a further embodiment, the first sequence comprises detecting a third event representing disappearance of the first source of activity in the first zone after detecting the first event and the second event.

In yet a further embodiment, the first event represents detection of the first source of activity in the first zone, and the second event represents absence of the first source of activity from the second zone, wherein the first sequence comprises detecting the second event prior to detecting the first event.

In a further embodiment, the first zone defines an aperture through which activities may be detected such as passage, and wherein the first event represents absence of a first source of activity from the first zone, and the second event represents detection of the first source of activity in the second zone, the method further comprising:
defining a third zone within the images such that the second zone is located between the first zone and the third zone; and
detecting a third event representing absence of the first source of activity from the third zone;
wherein the first sequence comprises detecting the second event after detecting the first event and the third event.

In another embodiment, the first zone defines an aperture through which activities may be detected such as passage, and wherein the first event represents detection of a first source of activity in the first zone, and the second event represents detection of the first source of activity in the second zone, the method further comprising:
defining a third zone within the images such that the second zone is located between the first zone and the third zone; and
detecting a third event representing absence of a first human body from the third zone;
wherein the first sequence comprises detecting the second event or the first event after detecting the third event.

In a further embodiment, the action performed in response to detecting the breach of security comprises activating an audible alarm.

In an embodiment, detecting the first human body comprises scanning images of the location in search for the human body using a pre-loaded image of the same or another human body.

The method may further comprise building a multidimensional space of samples including match samples (YES samples) and no-match samples (NO samples), the building comprising:
obtaining a plurality of sample images from an image bank, said sample images consisting of images that only show a human body and images that do not show a human body;
transforming each sample image into a binary format;
dividing each sample image into a plurality of areas;
providing different versions of the preloaded image of the human body in the binary format, each version having a different resolution, and dividing each version into one or more tiles, thus producing a number m of tiles from all the different versions;
performing the SSD between each sample image and each tile, to produce a first set of SSD values including m SSD values;
classifying each first set of SSD values in an m-dimensional space; wherein each first set of SSD values associated with a sample image showing only a human body is classified as a YES sample, and each first set of SSD values associated with a sample image not showing a human body is classified as a NO sample.

The method may further also comprise:
performing the SSD between each area of the given image and each tile of the pre-loaded image, to produce a second set of SSD values including m SSD values for each area;
classifying said second set of SSD values as a sample point in the m-dimensional space;
counting a number of YES samples and a number of NO samples within a predefined volume around the sample point associated with a given area;
calculating a third ratio of Yes samples versus No samples within the predefined volume; and
dividing the third ratio by a fourth ratio representing the number of Yes samples versus No samples in the entire m-dimensional space, thus producing an area-probability indicative of the presence of the human body in the given area.

In an embodiment, the method may further comprise:
morphing the pre-loaded image in a plurality of dimensions to produce morphed versions of the pre-loaded image, and
performing SSD between each morphed version of the pre-loaded image and each area to obtain a plurality of second sets SSD values;
outputting the second SSD set having the lowest values for classification in the m-dimensional space.

In an embodiment, if the image-probability is greater than a predetermined threshold, the system may output the position of the human body in the given image.

The method may further comprise outputting the size of the human body in the given image.

The method may further comprise outputting the position and size of more than one probability associated with different areas of the given image, thus detecting more than one human body in the given image.

In an embodiment the method may comprise comparing each one of the plurality of areas to a plurality of pre-loaded images, each preloaded image representing a different position of the human body.

In another aspect, there is provided a vision based computer-implemented method for detecting a breach of security in a location including a body of water, the method comprising:
storing a succession of events defining the breach of security and an action to be performed in response to detecting the breach of security, said succession of events comprising two or more events and a predetermined sequence in which said events are performed;
receiving a stream of images of said location from an image capturing device;
defining at least a first zone defining the body of water and a second zone adjacent the body of water within said images;
detecting a first sequence of events matching the predetermined sequence in said images, including:
   detecting a first event in said location;
   detecting a second event in said location;
wherein at least one of the first event and the second event represents detection of a child alone in said location;
performing the action associated with the breach of security, in response to detecting the first sequence.

In an embodiment, detection of the child comprises:
detecting a first human body;
detecting a size of the first human body; wherein detecting the size comprises:
   detecting a first angle between a first axis between a lens of the image capturing device and a head of the first human body and a second axis between the lens of the image capturing device and a foot of the first human body;
   estimating a distance between the image capturing device and the first human body using a second angle between the second axis and a vertical axis;
   determining the size based on the first angle and the second angle.

In an embodiment, detection of the child alone comprises detection of the child beyond a first pre-determined distance from a nearest adult.

In a further embodiment, calculating of the pre-determined distance is done as a function of a second distance between the child and the body of water, such that the child can walk the second distance before the adult reaches the child.

In an embodiment, the first event represents detection of the child alone in the second zone and the second event represents detection of the child alone in the first zone, wherein the first sequence comprises detecting the first event prior to detecting the second event.

In an embodiment, the first event represents detection of the child alone in the first zone and the second event represents disappearance of the child from the first zone, wherein the first sequence comprises detecting the first event prior to detecting the second event.

In an embodiment, the action performed in response to detecting the breach of security comprises one or more of: activating an alarm, calling a predefined number, generating an audible sound, requesting the detected person to perform a certain action, and providing/sending images of the monitored area to a third party for verification.

In another embodiment, the method further comprises:
detecting a predefined gesture performed by the adult after activating the alarm;
deactivating the alarm in response to detecting the predefined gesture.

In another embodiment, detection of the child is based on morphological size differences between adults and children. For example, the method may comprise calculating at least one of: head to shoulder ratio and head to body ratio; and comparing said ratio to a predefined threshold.

A vision based computer-implemented method for detecting a breach of security in a location including a body of water, the method comprising:
storing a succession of events defining the breach of security and an action to be performed in response to detecting the breach of security, said succession of events comprising two or more events and a predetermined sequence in which said events are performed;
receiving a stream of images of said location from an image capturing device;
defining at least a first zone defining the body of water and a second zone adjacent the body of water within said images;
detecting a first sequence of events matching the predetermined sequence in said images, including:
   detecting a first event in said location;
   detecting a second event in said location;
wherein at least one of the first event and the second event represents detection of a human body in said first zone;
performing the action associated with the breach of security, in response to detecting the first sequence.

In an embodiment, the method further comprises detecting that the human body is a child based on a size of the human body. In an embodiment, detecting the size comprises:
detecting a first angle between a first axis between a lens of the image capturing device and a head of the human body and a second axis between the lens of the image capturing device and a foot of the human body;
estimating a distance between the image capturing device and the human body using a second angle between the second axis and a vertical axis;
determining the size based on the first angle and the second angle.

In an aspect, there is provided a vision based computer-implemented method for detecting a breach of security in a monitored location, the method comprising:
storing a succession of events defining the breach of security and an action to be performed in response to detecting the breach of security, said succession of events comprising two or more events and a predetermined sequence in which said events are performed;
receiving a stream of images of said location from an image capturing device;
defining at least a first zone, a second zone adjacent the first zone, a third zone adjacent the second zone and an aperture through which people may enter or leave the location within said images, wherein the aperture is adjacent the first zone such the first zone separates between the aperture and the second zone;
detecting a first sequence of events matching the predetermined sequence in said images, the first sequence including the following events:
   at T0 detecting appearance of a first human body in the aperture;
   at T1 detecting the first human body in the first zone and a second human body in the aperture;
   at T2 detecting the first human body in the second zone and the second human body in the first zone;
   at T4 detecting the first human body in the third zone and one of: disappearance of the first human body from the second zone or disappearance of the second human body from the first zone;
performing the action associated with the breach of security, in response to detecting the first sequence.

In the present document, the following terms are used interchangeably to mean the same thing:
“ideal image”, “ideal image of the meta-subject”, and “ideal image of the human body”;
“Breach of security” and “intrusion”;

In the present document, the term meta-subject is used to indicate the object that the system searches for in the images received from a camera, to extract its position and/or size within the image. In the present embodiments the meta-subject is a human body.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. The terms comprising and including should be construed as: including but not limited to.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates an example of a vision based system for detecting an intrusion, in accordance with an embodiment;

FIG. 2 is a block diagram of an exemplary intrusion detecting device in accordance with an embodiment;

FIGS. 3a-3i illustrate an example of detecting an intrusion using images of the monitored area;

FIGS. 3a-1 to 3i-1 illustrate the logic tables corresponding to the images shown FIGS. 3a-3i, respectively;

FIG. 4 illustrates an embodiment of an image analyzer used for detecting an object in an image and delivering the position and size of the object in the image;

FIG. 5 illustrates a non limiting example of a block diagram of a scanner module in accordance with an embodiment;

FIG. 6 illustrates a non-limiting example of different postures that may be used as the image and that may be used as Yes samples;

FIG. 7 illustrates examples of images that do not show a human, for use as No samples;

FIG. 8a illustrates an exemplary three dimensional space including a plurality of reference samples of images representing humans which are considered as the “Yes” samples, and images not containing humans which are considered as the “No” samples;

FIG. 8b illustrates a two-dimensional illustration of the 21 dimensional space representing a slice along two dimensions;

FIG. 9 illustrates a pyramid including three resolution levels for the image of the ideal human;

FIGS. 10a to 10d illustrate examples of images showing a human body in different locations/zones;

FIG. 11 illustrates another embodiment of the image analyzer shown in FIG. 4;

FIGS. 12a to 12c illustrate an example of how to detect different human bodies with different sizes;

FIGS. 13a to 13c illustrate an example of detecting multiple human bodies and associating them together;

FIGS. 14a to 14F are images/frames of an exemplary clip defining a normal behavior;

FIGS. 15a to 15F are images/frames of an exemplary clip defining an abnormal behavior;

FIG. 16 illustrates a hypothetical three dimensional space including a plurality of reference samples of clips representing normal behaviors, and clips representing abnormal behaviors;

FIG. 17 is a flowchart of a vision based computer-implemented method for detecting a breach of security in a monitored location, in accordance with an embodiment;

FIG. 18 is a flowchart of a vision based computer-implemented method for detecting a breach of security in a monitored location, in accordance with another embodiment;

FIG. 19 is a flowchart of a vision based computer-implemented method for detecting a breach of security in a monitored location in accordance with yet another embodiment;

FIG. 20 is a flowchart of a vision based computer-implemented method for detecting a breach of security in a monitored location in accordance with yet another embodiment; and

FIG. 21 illustrates an exemplary diagram of a suitable computing operating environment in which embodiments of the invention may be practiced.

It will be noted that throughout the appended drawings, like features are identified by like reference numerals.

### DETAILED DESCRIPTION

The embodiments will now be described more fully hereinafter with reference to the accompanying drawings, which form a part hereof, and which show, by way of illustration, specific embodiments by which the embodiments may be practiced. The embodiments are also described so that the disclosure conveys the scope of the invention to those skilled in the art. The embodiments may, however, be embodied in many different forms and should not be construed as limited to the embodiments set forth herein.

Among other things, the present embodiments may be embodied as methods or devices. Accordingly, the embodiments may take the form of an entirely hardware embodiment, an entirely software embodiment, an embodiment combining software and hardware aspects, etc. Furthermore, the embodiments may be implemented on desktops, laptop computers, a portable or handheld devices, tablet devices or any computing device having sufficient computing resources to implement the embodiments.

Briefly stated, the embodiments describe a vision based system and method for detecting a breach of security in a monitored area. One or more sequences of events are stored in the system. Each sequence of events includes a different combination of events and an order in which the events have occurred. An action is associated with each sequence of events such as triggering an alarm, generating an audible sound, calling 911 etc. when the events detected by the system match a given sequence the action associated with that sequence is performed. The system receives an image stream of the area and detects the events occurring in the images including the detection of a human body, its size and location within the monitored area.

FIG. 1 illustrates an example of a vision based system for detecting a breach of security (aka intrusion), in accordance with an embodiment. The system comprises an image sensor 20 e.g. a wide range camera, operably connected to an intrusion detecting device 22 (aka device 22) for analyzing the image stream received from the camera 20 for detecting an intrusion in the area that is monitored by the camera 20.

The system may be activated at all time to detect abnormal activities and/or successions of events defining a breach of security without requiring people in the monitored area to change their normal behavior. In other words, if the system is installed to monitor a certain area, people within the area may move and act normally without risking triggering an alarm because the system tracks the previous zone of activity in order to determine whether or not the events define a breach of security. For example, detection of someone in the door area then in an area beside the door does not necessarily mean that there is an intrusion because the person may simply be walking in front of the door. By contrast, if the person was not detected outside the door area prior to appearing in the door, this may be interpreted as an intrusion, as will be described in the examples provided below.

FIG. 2 is a block diagram of an exemplary intrusion detecting device in accordance with an embodiment. As shown in FIG. 2, the device 22 comprises an image analyzer 310, a movement detector 410, and a sequence analyzer 510, in a non-limiting example of implementation. In an embodiment, the image analyzer 310 is configured to search for and detect a human body within the image stream received from the camera 20 along with the position and size of the body within the image. The movement detector 410 is adapted to detect a movement/displacement of the body and discriminate the movement of a human from the movement of an object (which is implicit because the image analyzer is configured to detect humans as described below). The sequence analyzer 510 is adapted to flag the crossing of the perimeter (aka intrusion) when a predefined succession of events occurs. A number of zones may be established within the image. An example of an event may include the appearance of a human body, or the detection of a movement of the human body within or across one of the zones, as exemplified in FIGS. 3a to 3d.

FIGS. 3a-3d illustrate an example of detecting an intrusion in an area within the field of view of the camera. FIG. 3a illustrates the area at the time T0 where no objects (humans or animals) are detected. As shown in FIG. 3a, the area that is monitored is a wall having a door therein. In the present example, the monitored area is divided into three zones: an aperture which represents the door, a zone A which represents the area in vicinity of the door, a zone B in the vicinity of the zone A, and a zone C which represents the wall in which the door is provided. FIG. 3a-1 illustrates a logic table that represents the logic state of each of the zones in FIG. 3a, and the indication of what the movements mean. As shown in FIG. 3a-1, the system is in a relaxed state since no human is detected in any of the zones.

In a non-limiting example of implementation, the present document applies a logic whereby, although some zones seem to be surrounding each other e.g. B surround the aperture and A, and C surrounds the apertures A and B etc. detection of activity in a certain zone means that the human body exists within the perimeter of that specific zone only excluding the case where the human body exists within the perimeter of another zone within that zone. In other words, detection of activity within the aperture does not mean that the source of activity is in zone A or B or C. Also detection of the human body in zone A does not mean that the human body is in zone B or C (unless the human body is crossing the perimeter from one zone to the other) zone A means that the source of activity exists within the perimeter of zone A, and the detection of a source of activity in zone B means that the source of activity is detected within the perimeter of zone B and outside the perimeter of zone A, and the detection of a source of activity in zone C means that the source of activity exists within the perimeter of zone C and outside the perimeter of zone B.

In a non-limiting example of implementation, assume that the area shown in FIG. 3a is the interior of a bank whereby after business-hours employees and clients who are being served may leave, but no further clients may come past a certain zone (zone A). In the present scenario, the intrusion may be defined as the succession of the following events in the following order: 1) detection of a person entering through the aperture zone (this step is optional since the person may not always be caught while entering e.g. if they open the door slightly and sneak in), followed by 2) appearance of the person in zone A, followed by 3) disappearance from A, followed by 4) appearance of the person in zones B or C. By contrast, detection of a person going in the opposite direction (C then B then A then aperture) and leaving through the door is not considered as an intrusion. Furthermore, if the person arrives at zone A and disappears to return to the aperture, this may not be taken as an intrusion since this is the typical case of someone accidently opening the door or someone opening the door on purpose and returning before passing the no-pass zone after they realized that it is past business hours.

Accordingly, a possible succession of events that defines an intrusion may be as follows:

| Order/sequence | Events |
|---|---|
| 1 | Appearance in A |
| 2 | Disappearance from A |
| 3 | Appearance in B or C |

FIG. 3b illustrates the area at time T1 where a human body appears in the aperture zone. FIG. 3b-1 illustrates the logic table that corresponds to FIG. 3b. As shown in FIG. 3b-1, the state of the aperture zone has changed from 0 to 1 to indicate that the presence of a human body within the perimeter of that zone. FIG. 3c illustrates the area at time T2 where the human body appears in zone A. FIG. 3c-1 illustrates the logic table that corresponds to FIG. 3c. As shown in FIG. 3c-1, the states of zones B and C remain the same but the states of zones A and the aperture has changed to indicate the disappearance of the source of activity from the aperture and its appearance in zone A.

FIG. 3d illustrates the area at time T3 where the source of activity appears to be crossing zones A toward zone B. FIG. 3c-1 illustrates the logic table that corresponds to FIG. 3c. As shown in FIG. 3c-1, the states of zones A and B are both 1 to indicate that the human body is crossing the border between the two zones as illustrated in FIG. 3d.

FIG. 3e illustrates the area at time T4 where the human body appears in zone B outside of zone A. FIG. 3e-1 illustrates the logic table that corresponds to FIG. 3e. As shown in FIG. 3e-1 the state of zone A has changed to become 0 since the person is no longer within that zone.

The sequence analyzer 510 monitors the events detected by the image analyzer 310 and/or movement analyzer 410 and the sequence in which the events are occurring. In the present example, once the image in FIG. 3e is received and processed the sequence analyzer 510 may flag the detection of an intrusion because the events detected in images 3b to 3d match the pre-defined succession of events. In other words, a human body was detected in Zone A at T1, the human body was detected in zone A, then disappeared from A to appear in B.

By contrast, if the movement was detected in Zone C then, across C toward B, then from B to A, the system may understand that this sequence of movements is typical to a person leaving the protected area rather than entering it, and no intrusion is flagged since the sequence does not match the pre-stored sequence of events.

It is to be noted that the embodiments of FIGS. 3a to 3e associate each figure with a timestamp T0 to T4, respectively, for simplifying the understanding of the concept. However, it is to be understood that FIGS. 3a to 3e are not necessarily successive frames. In fact few frames may elapse between each Figure and the other during which the system may estimate the next state based on the movement direction. However, the next state becomes effective only upon receiving the frame(s) that confirm it.

Furthermore, the succession of events described above is only an example. It is possible to implement different and more than one succession of events for the same monitored area, depending on the particularity of each case. In a non-limiting example of implementation, the succession of events may include only two events. Thus two zones may be sufficient for detecting an intrusion when only one intruder is performing the intrusion. One possible example would be: appearance of the person in the aperture then appearance of the person in zone A. Another case would be appearance in A without prior appearance in B, or appearance in zone B without prior appearance in zone C. etc.

In a further embodiment, there are scenarios where more than one person perform the intrusion (e.g. robbery) together, as exemplified in FIGS. 3f to 3i. In the present scenario, assume that FIG. 3b is followed by FIG. 3f at T2 instead of FIG. 3c. As shown in FIG. 3f, a person is detected in the aperture and another person is detected in zone A. FIG. 3f-1 illustrates the logic table that corresponds to FIG. 3f. FIG. 3g illustrates the area at T3 and FIG. 3g-1 illustrates the logic table that corresponds to FIG. 3g. As shown in FIG. 3g, there is an intruder in zone A and another intruder in zone B. Accordingly, the previous succession of events applied to FIGS. 3a to 3d would not have worked because there was no disappearance from zone A, since one intruder replaced the other in zone A. The scenario may then evolve in two manners. It is either that the person in zone B would move to zone C alone leaving no person in zone B as shown in FIG. 3h, or that both persons would move one zone forward as shown in FIG. 3i. FIGS. 3h-1 and 3i-1 illustrate the logic tables that correspond to FIGS. 3h and 3i, respectively.

In the present case, a possible succession of events to detect the intrusion may be as follows:

| Order/sequence | Events |
|---|---|
| 1 | Appearance in A |
| 2 | Appearance in B |
| 3 | Disappearance from A or B |
| 4 | Appearance in C |

Following the detection of an intrusion, an action may be performed by the system such as triggering an alarm, calling security, or the like.

It is to be understood that the system is not limited to monitoring walls or doors, and may be configured to monitor any area within the field of view of the camera 22, regardless of the presence of physical delimiting means e.g. fence, borders, painted lines etc, or not. For example, the system may be configured to monitor a body of water (hereinafter referred to as swimming pool or pool) and trigger the alarm when a child approaches within a certain distance of the pool edge, even though no physical fence exists around the pool.

In an embodiment, it is possible to implement a plurality of phantom fences around the monitored area wherein when a first fence is crossed, a first alarm is triggered as a warning when a child is within a certain distance of the pool edge, and when the second fence is crossed or when the child is too close to the pool edge and the distance between the child and the parent does not give the parent sufficient time to reach the child before going in the pool a second alarm and/or an automatic call for assistance is triggered. In the latter case, the second alarm may be triggered based on the direction and speed of movement of the child, the distance between the child and the pool, and the distance between the child and the parent.

In an embodiment, the aperture through which people disappear (e.g. Zone A defining the door) may be predefined during set-up. However, it is also possible to train the system to detect the aperture and define its boundaries automatically by monitoring the area within the image in which people disappear and/or appear.

It should be noted that it is possible to configure the system to have a plurality of succession of events for the same area. For example, if the image shown in FIG. 3a is detected at T0 and the image shown in FIG. 3d is shown at T1, the system may also flag the detection of an intrusion since the human body did not appear in C outside of B before appearing in B outside of A. This is the typical case of an intruder opening the door slightly and sneaking in immediately before being caught by the camera. In the present example, a possible succession of events for this type of intrusion may be:

| Order/sequence | Events |
|---|---|
| 1 | No human body detected in |
| | C outside of B |
| 2 | Appearance of a human |
| | body in B outside of A |

Examples of events may include: appearance of the human body in one of the zones, disappearance of the human body from one of the zones, crossing a perimeter of one zone toward the other, movement in one of the zones, crossing one zone toward the other, change of size of the human body, detection of more than one human body, events based on the distance between one human body and the other etc.

In an embodiment, the number of zone is minimally 2 but can be dramatically increased to reach a 1000 or more by establishing a succession of zones or tiles around the area to scan. The intrusion logic is of the same nature, establishing a path of successive presence of events/activities. Theses can be either learned or derived from a synthesis of obvious scenario on a limited set of tiles, or a combination of both.

Detecting a source of activity such as a human body can be done with a movement detector that can be based for example on differences of pixel values from one frame to another. Such difference may be rounded to a certain tolerance to account for natural noise of the sensors. Then a subtraction from frame to frame can preclude an activity in place where pixel differences is non null. The difference between frames can be processed with a convolution module that will emphasize the object of a certain convexity, and use blobs algorithm in computer vision to establish if a pixel mass of a decent size is in movement.

Activity detection can also be computed using information from an object detector tailored for a certain target, like a human body. Such detection of movement searches first for a specific aspect of an object within the image and establishes the activity by a change in a center of gravity or equivalent measure like change in overall length of the perimeter of the object or variation of ratio X/Y of the bounding box that contain the object. The main embodiment uses the center of gravity of the detected object.

Object oriented activity detection may be used for accounting for more natural variations of the environment as well as establishing additional parameters like size of the object which generates the activity, allowing more elaborate action associated with intrusion or extrusion, like differentiating a child from an adult both close to a pool surrounded by zone of perimeter analysis.

The detector may incorporate sub-object detector(s). For example, a human body detector may incorporate a head detector that may incorporate an eyes detector. With this information, false detection like movement of a shadow across a window but from outside the scan perimeters can be avoided (shadows rarely exhibit aspect that can be misinterpreted with all the details of a body like the eyes).

The main embodiment uses a method for classifying an object seen in the scene to find if the object of the scene belongs to the class of a principal object (aka the meta-subject). For example, the embodiments may objects appearing in an image to confirm whether one of these objects is a human body (e.g. the human body being the meta-subject).

### Generic Classification

The following description relates to the detection of an object (e.g. human) within an image. In this case, the feature points used for the detection are extracted from the difference between the image of an ideal object (a human body) and a portion of the image received from the camera 20.

In the present document, a class is defined as being a collection of objects of a relevant similarity, relevant in the sense that objects of the same class would have similar classifications by the system. The embodiments describe a classification system and method which classify humans (who belong to the same class) in a similar manner, while non-humans are classified differently or not classified.

Although the methods described herein may be tailored and used for identifying a specific person from a group of people (e.g. for security purposes), it should be noted that the present embodiments are used for distinguishing humans from non-human objects for the purpose of identifying a human movement defining a breach of security. It should also be noted that the embodiments may also be applied for detecting animals and/or other objects, without departing from the scope of this disclosure. For example the embodiments may be used for detecting passage of animals through a gate or the like.

The detection process comprises a training/learning session that precedes the detection of humans from the image stream. In the training session, a set of non human samples e.g. images that do not include humans (aka No samples) and a set of human image samples (aka Yes samples) are fed into the system and classified in a multidimensional space, wherein the metering function used for classification has a certain monotonicity wherein objects (aka meta subjects) of same appearance are characterized by values of same/similar amplitudes. The Yes samples tend to cluster in the multidimensional space defining a certain volume because they show similar objects (humans) while the No samples disperse in the multidimensional space because they show unrelated objects e.g. cars, houses, animals etc.

The next step would be to process the images received from the camera 20 to determine the likelihood that a human is shown in the pictures. The process involves classifying the image as a sample point in the multidimensional space including the Yes and No samples to determine whether or not the image contains a human based on the position of sample within the multidimensional space and the number of Yes samples and No samples within the volume that surrounds the sample point.

In order to teach the human detector how a human may look like, and the difference between a human and other objects in the universe, the ideal method to detect would be to feed all images in the universe showing a human and all images in the universe not showing a human to the detector in order to inform the detector of the differences and similarities between the submitted sample and the rest of world not including a human. If that was possible we would be sure and certain to find the image of any human of any individual in such database. In such database the radius of exploration to find the sample is zero because the sample is there. The method would be of a deterministic nature. However, in reality, there is no method of direct access to this hypothetical infinite bank space and the decision need to be taken using a far more limited subset to get a discrete and decent count of data for the bank. The amount of samples also needs to be compatible with the processing power available for the apparatus.

This involves a limited set of images used as references. This limited set of images represents one draw from an infinite set of images from the universe. Accordingly, the method of detecting an image is of a probabilistic nature (rather than a deterministic nature).

In this case, there is a need for radius of exploration of a certain size around the sample in order to have a chance of finding the submitted human using samples from the draw. The challenge is then to find a good enough metering method to convert the bank of reference images to a database of values, and have a sufficient amount of samples in the database such that the volume defined by the radius may include a sufficient amount of samples for discrimination.

In this bank of sampled images based on the sampling method, a good metering method will create an attractor for the subject to recognize, around which all the images of similar aspect will group allowing an easier determination of the class that the object belongs to. For example, a naive metering method going from pixels to a single value may include a blunt subtraction of a submitted image containing a human to a reference image of a human, then summing all normed differences, to deliver a single outcome, this can be expected to show a smaller value when applied to images containing another human than to an image containing a car or tree or a non-human object.

This crude approach requires a very large number of “Yes” and “No” samples in the database in order to output a reasonably educated guess, because the volume or search around a specific candidate point is small and the search requires a certain number of samples within the volume. In other words, the density of Yes samples around a specific candidate sample needs to be very high because the radius of exploration around the specific sample needs to be very small to avoid errors.

Accordingly, when dealing with real samples available for learning, it is needed to increase the number of values revealing a shape to detect and find a comparison method that is intrinsically more adapted to a small variation of aspect. In the preferred embodiment a set of 21 values have been chosen, and to increase the pertinence of each set, and improve the monotonicity of the transformation from a N-tuple of data (images) to a P-tuple of features for classification, a best fit process has been adapted to select the best values amongst many comparisons.

The embodiments aim first at establishing the best possible transformation from the real image space (reality) to the smallest possible number of values, where the transformation is expected to keep most or at least sufficient amount of the characteristics of the original image to allow discrimination of the subject versus all other images. The discrimination process then uses a reference set including a subset of the limited bank of images. Then the classification within this space of small number of values becomes easier, aiming at delivering a revealing single final outcome that the submitted Image contains a human. As this bank is just one ‘draw’ of the infinite reality, any evaluation of similarity to this limited subset is of a probability nature. It involves an unknown and incomputable probability that the draw represent the reality.

But if the draw is representative enough and the transformation is carrying enough of the characteristics of the object to classify, then the results of the transformation of a sampled image can be consistently compared to the draw set or between them or to a model, delivering a probability like outcome. Therefore if the subset is well chosen, the probability that the draw is representative of the humans in the world would be very high and the outcome of the detector will carry on this high probability. Even if the relevancy of the draw to universe cannot be known, the more “Yes” samples (image that belong to the class) and the more “No” samples (images without member of the class) are used, the more the bank will converge to this hypothetical value. In other words, as a general rule the more known samples we have in the database the more accurate the results would be(known in the sense that they are known as being YES or NO).

This model allows for measuring the consistency of the chosen bank of images in the lab as test and feedback allow for a trial/error experiments to see when convergence reaches an acceptable level when testing a probe set of humans. The learning bank may still benefit from an increase in samples, either satisfactorily if using a specific image like an exact human of the user, or the user's living room or office as backgrounds.

In an embodiment, the learning bank of samples is built using the comparison values between a plurality of images and an ideal image or a plurality of ideal images of the subject (in this case a human body). In the present case, each comparison produces a different set of 21 values. For example, each one of the images in FIG. 7 will produce a different set when compared to each one of the ideal images 345-1 to 345-7 of FIG. 6.

In an embodiment, the database may be split in sections, each section may be associated with an ideal image of the meta-subject (human body) e.g. images 345-1 to 345-7. In another embodiment, the database may contain all the coordinates in a single folder with an index of which coordinates correspond to which ideal image. This allows for more elaborated use of the database so that for example when considering one comparison to one meta-subject, a selection of the other can be considered as “No” samples. This allows for a better use of the image set information. This also allows for organizing the similarity by proximity of aspects and for using this proximity. For example while searching for Meta-subject 345-6, meta-subjects 345-5 and 345-7 exhibit higher values than the rest of the images in FIG. 6. Such values may be used as a confirmation and may also be used in an aggregation process to increase the pertinence of the very final outcome. This is only one example of how the computed data relative to multiple meta-subjects may be used. For sake of clarity the embodiments below will be explained with respect to a single meta-subject.

In an embodiment, the ratio of similarity between a submitted sample and human is computed by counting all the Yes samples and the No samples in the vicinity of the submitted sample in the database. Subsequently, this ratio is divided by the same ratio of samples but using all samples from the database in order to produce the ratio of final similarity.

This transformation is expected to be consistent enough (reproducible) and the art is then restricted to the handling of a set of N-tuple sampling values (set of pixels of an Image). The associated bank of discrete values will be hereinafter referred to as database. In the following discussion, the size of the digitized subset is said to be of an N dimension where N is for example=640*480 pixels.

On a sample set of a defined dimension N, (a N-tuple) then transformed to a system of values (a coordinates system) of P values (a P-tuple), the confidence of similarity is correlated to the density of similar samples within the vicinity of the sample submitted once transformed from a N-tuple to a P-tuple. Accordingly, in the database of a coordinate system of P dimension using a transformation, the best similarity result should aggregate around a volume of choice, also called vicinity of the sample. The size of the vicinity is a trade-off between being too small then missing a human in an image and being too big then allowing artifact to be detected as humans. The way this size is chosen is explained below.

The restriction of definition of the detection as generalized above can be summarized mathematically as to find a transformation from [symbol] ^{N}-> [symbol] ^{P} where N is typically the dimension of images in pixels, and P being another space typically of smaller dimension where the handling of the N-tuple data set from [symbol] ^{N} is expected to be far easier than in [symbol] ^{N} itself.

This is the essence of classification in the art of Image detection. The challenge is then is to find an appropriate transform fₖ [symbol] ^{N}-> [symbol] ^{P} that keeps as much as possible of the features of interest of the N-tuple from [symbol] ^{N} (the Images data set of pixels) to a P-tuple from [symbol] ^{P} for easier handling.

Accordingly, the embodiments attempt to find a reduction function fₖ which allows reducing the number of dimensions from N to P, where P is not more than a couple of dozens (in a non-limiting example of implementation). The surjective (one or more origin for the same destination) capability of fₖ allows for feeding the detector with images of various dimensions without decimating information as it could happen for example if normalized with a zoom to a standardized dimension required by some other image detector. Otherwise said the function fₖ may be such that different N values can inject in a single value P to allow comparison of N-tuple of different N dimensions to the same database of P dimensions. It is of interest to consider a small enough P and a function that allow the P values to be used as a coordinates system so that the database of learned samples can be seen as a multidimensional space (P) and the probed sample will be at specific coordinates surrounded by learned known samples so that they can easily be enumerated.

As explained hereafter the preferred embodiment are implemented using a value of P=21 for image of N pixels, and the fₖ function is a succession of 3 operations involving a search for a best match of a model within a convolution of the candidate image.

### Human Detection (Image Analyzer)

FIG. 4 illustrates an embodiment of the image analyzer 310 used for detecting the object (human) in an image and delivering the position and size of the object in the image.

As shown in FIG. 4, the image analyzer 310 receives a stream of images 340 from the camera 20. In an embodiment, the image analyzer 310 comprises a convolution module 342 adapted to process the images 340 received from the camera 20 to enhance peculiarities of the image such as edges and for making the image in a binary form allowing fast comparison between the images 340 and an ideal image 345 stored in memory which has also been processed in the same manner. The binary version 344 of the image 340 is sent to a scanner module 346 for search and evaluation.

The scanner module 346 receives as inputs a convoluted version (binary version) of an ideal image 345 of a human (which is preliminary processed using the process 342), and a convoluted version 344 of the image 340 received from the camera 20 and outputs the highest probability of the presence of a human in the image 344, the size and the position of the human in the image 344. In other words, the scanner module 346 outputs: 1) the highest probability that a human is found in the image 344, 2) where the human was found, and 3) the size of the human within the image. In an embodiment, the scanner module may have access to a local database 350 and/or a remote database/server 352 via a telecommunications network 354 for obtaining reference samples used for computation as will be described hereinbelow.

In an embodiment, the scanner module 346 is connected to a probability sorting module 348 which is adapted to eliminate probabilities that are below a predefined threshold.

Accordingly, the image analyzer outputs the size and position of the human within the images received from the camera 20.

FIG. 5 illustrates a non limiting example of a block diagram of a scanner module in accordance with an embodiment. As shown in FIG. 5, the scanner module 348 receives the binary image 344 and subdivides it into a plurality of areas 359 (e.g. rectangles) of various sizes as shown at 360. The size of the rectangle depends on the size of the image of ideal human 345 once morphed. Each one of the areas is scanned in order to evaluate the probability of the presence of the object (human) in it.

In an embodiment, the search is done using steps of four pixels repeated over the entire candidate image (the embodiments are not limited to four pixels, and may be implemented with different numbers of pixels depending on the size of the area 359 and the resolution of the image). In other words, the area of search is moved by four pixels at each iteration. Whereby adjacent areas 359 may have overlapping pixels. The intent of this method is to find the best match that leads to the lowest Sum or Square Difference (SSD) values.

For example, if the image size is as follows: 1024 pixels*1024 pixels, the resolution may be lowered by a factor of four thus obtaining an image of 256 pixels*256 pixels. With a stepping rate of 4 pixels this leads to a (256/4)*(256/4)=4096 areas of interest (rectangles). Pixels of each area of the 4096 rectangles are fed to an SSD computation module 362 which is adapted to evaluate the difference between each rectangle and many morphed (distorted) versions of the ideal image of the human 345 produced using a morphing module 361

The number of distorted versions used in each cycle may be in the range of 1000 representing various scaling and rotations of the human 345 in order to maximize the chance of finding a decent match in the image 340, otherwise said in order to get a better representative SSD (of a low value then) many attempts are made to see if an adapted version of the tile doesn't exhibit naturally a certain level of similarity. For example, the morphing module may apply one or more combinations of: + to −10 degrees rotations by increments of 2 degrees for each rotation, 20 scaling levels, five x-y distortions for each scaling level etc.

In an embodiment, a plurality of ideal images 345, each defining a different posture, may be provided to the scanner module 346 to compare the image 344 to each of the images 345 for a better detection of a human body. FIG. 6 illustrates a non-limiting example of different postures that may be used as the image 345.

Referring back to the SSD computation module 362, this module performs the sum of the square of the difference between pixels of each of the morphed versions 345 and each rectangle 359 in the binary image 360 to determine the likelihood that a human exists in the rectangle 359. The SSD module 362 is adapted to find the best match from all the morphed versions tried on each rectangle 359. The result of the best match search between each candidate image 344 and the morphed versions of the ideal image(s) 345, is the lowest SSD values found for each candidate image 344. Needless to say, the SSD values are the lowest when the image 344 contains an object that is similar to the object shown in the image 345. This best match search must only be seen as an implementation decision allowing to decrease the probability evaluation step of “yes”/“no” volume, which otherwise can be done for every morphed version of the meta-subject but this would increase the computational load without major improvement over the results provided by the best match principle which requires much less computations. In other words, the best match approach provides for improved results with less computational efforts on the computing device.

In an embodiment, the comparison process for each image 360 is divided into 21 comparisons performed in pyramidal manner as will described herein below. It should be noted that the number 21 in this context is only an implementation decision. However, the embodiments are not limited to such constraint. In an embodiment, the SSD computation module 362 performs the comparison in a loop whereby each rectangle 359 is compared to each morphed version of the image 345, in order to choose the lowest 21 SSD values. It should be understood that the 21 values are considered as a set. This process is repeated to find the lowest 21 values for each rectangle 359. The number of comparisons made for each image may reach approximately 4 millions.

In an embodiment, the parameters used to morph the image 345 which lead the lowest 21 values are kept for use in determining the final computation, position, and size of the human.

Referring back to the SSD computation module 362, this module 362 outputs the 21 best match values (lowest values) for each rectangle 359 in the image 360. In the present example, selection of the number of values is described herein below.

The SSD computation module 362 outputs the 21 values but carry also the position and size of the human within the image. The enumeration module 364 weights the 21 values and delivers a probability that the 21 values represent a human based upon the reference samples provided in the database 366. The database 366 may be a local database and may also be fed/updated by a remote server over a telecommunications network.

Inside the enumeration module, the 21 values are used as coordinates of a sample point in a 21 dimensional space. The 21 dimensional space contains the 21 values (coordinates) preloaded in the database 366 for the Yes and No samples. Each set of 21 values represent the output of SSD computation module 362 applied on images received from an image bank (not shown). The bank of images stores images that include humans and only humans (as exemplified in FIG. 6), and images that do not contain humans (as exemplified in FIG. 7). The set of 21 values associated with images that include only humans are considered as YES samples (or match samples) in the multidimensional space, while the 21 values associated with images that do not contain humans are considered as “No” Samples.

By essence, when images that include a human are compared to the ideal image of the human 345, the set of 21 values which are the outcome of the SSD computation module 362 for these images will be low and probably similar. By contrast, when images not including humans are compared to the image of the ideal human 345, the set of 21 values which are the outcome of the SSD computation module 362 will be high and not similar at least for a few of them (along few of the dimensions). This should be understood as a search/comparison of each individual image of the meta-subject. This operation must be repeated for each image of the meta-subject that had been chosen as pertinent for the implementation e.g. images 345-1 to 345-7. In an embodiment, it is possible to apply an implementation method to speed up the multiple analysis of multiple images of the meta-subject. As a crude example of this implementation, the similar part of each tile of meta-subjects can be pre-analysed so that a match will be considered as relevant for the entire category.

The 21 values represent the coordinates of points in the 21 dimensional space. Accordingly, the sets of 21 values associated with images that have humans include coordinates that will cluster in the 21 dimensional space and should exhibit a rather monotonic comportment simultaneously in all dimensions. By contrast, the sets of 21 values associated with images that do not have humans may have good score of matching in one dimension but can simultaneously express a bad result in another dimension, hence tend to disperse even if sometime close to the edge of the hypercube. An example is provided below with respect to FIGS. 8a and 8b.

FIG. 8a illustrates an exemplary three dimensional space including a plurality of reference samples of images representing humans which are considered as the “Yes” samples, and images not containing humans which are considered as the “No” samples. As shown in FIG. 8a, the Yes samples form a cluster while the No samples disperse in the space. It should be noted that FIG. 8a is only a hypothetical example in three dimensions which is only intended for illustration purposes while the real embodiment is implemented using 21 dimensions (which cannot be illustrated to humans, but can be implemented in machines because an additional dimension for a machine means simply an additional index).

FIG. 8b illustrates a two-dimensional illustration of the 21 dimensional space representing a slice along two dimensions. In FIG. 8b, the white dots represent coordinates associates with No samples, while the black dots represent coordinates of Yes samples. As illustrated in FIG. 8b, the white dots tend to define high and low random values within the space, and this is due to the high differences they have with the ideal image of a human.

In an embodiment, the enumeration module 364 applies for each rectangle 359 the 21 values output by the SSD computation module 362 in order to determine a probability that the rectangle being examined shows a human. In one embodiment, the enumeration module counts the YES and NO samples around that point within a volume of a reasonable size, and divides the number of Yes samples by the number of No samples to obtain a ratio of YES versus No samples within the volume. This ratio is then divided by the ratio of Yes samples versus No samples in the entire database (space). The resulting number represents the probability that the rectangle in question contains a human. Accordingly, the more samples there is in the database the more accurate the results will be. In an embodiment, a surface interpolation method may be used to synthesise “yes and “no” samples in an area of the space having a poor density of samples in order to avoid computational error or wrong rounding.

The size of the reasonable volume around a certain sample may be defined in a variety of methods. In one method, the size is related to the density of the database such that the volume must contain a certain percentage of the entire count of samples in the database. In another embodiment, the size of the reasonable size may be related to size of the smallest volume that may be found in the space which includes a specific set of samples representing humans. In another embodiment, the size may be dynamically sized (variable) along one of more of the dimensions until one of the above criteria is met. Other methods may also be used without departing from the scope of the embodiments.

Referring back to the enumeration module 364, this module performs the processing in a loop on all the areas 359 (as they shift by four pixels as described above), until the entire image is scanned.

### Guided Search

In an embodiment, the system may be configured to implement a guided search approach for expediting the comparison process, whereby based on the SSD values of a given rectangle 359, the system may determine the likelihood of finding a relevant rectangle that includes the meta-subject in the vicinity of the given rectangle 359. In a non-limiting example, the system may be configured to determine the likely position and/or the likely direction toward that relevant rectangle from the given rectangle by monitoring the change in the SSD values between a rectangle and another for each dimension and using a prior knowledge of where the YES samples densely exist in the multidimensional space.

As discussed above, the probability that a certain rectangle includes the meta-subject is based on the position of the sample in the multidimensional space. Therefore, the 21 SSD values corresponding to a rectangle including the meta-subject have to be coherent on the entire 21 dimensions in order for the sample point to fall in a location where the number of Yes samples is more than the No samples. Subsequently, it is sufficient for a given sample to be off (in the sense of far, or de-phased) on a single dimension to be interpreted as not including the meta-subject.

However, knowing where the YES samples densely exist in the multidimensional space, the system may determine that a given rectangle 359 is close to the rectangle that includes the meta-subject or not based on the SSD value associated with each dimension. Using this approach the system may skip certain rectangles without risking missing the meta-subject if the current rectangle is very far. For example if a certain SSD value of a given rectangle is very far from the region that is dense in Yes samples, and/or if the sample is off on many dimensions, the system may skip a number of rectangles around the given rectangle and start the search somewhere else in the image.

Choice of 21 Values (Pyramid Comparison)

As discussed above, the SSD module 362 performs a sum of square difference of pixels between each of the morphed versions 345 of the ideal human and each rectangle 359 in the binary image 360. In a non-limiting example of implementation, the comparison process for each image 360 comprises 21 comparisons performed in pyramidal manner, whereby different morphed versions of the ideal human are compared to each rectangle 359.

FIG. 9 illustrates a pyramid including three resolution levels for the image 345 of the ideal human. A level 0 which has the highest resolution and includes 16 tiles, a level 1 which has a medium resolution and includes four tiles, and a level 2 level which has the lowest resolution and includes a single tile. In an embodiment, the scan begins with the level 2 image (image of the entire human in a single tile) to perform one comparison, then proceeds to the level 1 to perform 4 comparisons e.g. comparing each of the four tiles of the image to the rectangle 359 in question, then proceeds to the level 0 image to perform 16 comparisons, thus resulting in 21 comparisons. The 21 comparisons provide a set of 21 values associated with each rectangle 359. The 21 values are the coordinates of the sample point representing the rectangle in a 21 dimensional space.

The progressive comparison from coarse resolution (level 2) to finest resolution (level 0) allows increasing speed and efficiency giving the opportunities of using guidelines for the search of lower tiles. For example, the centre of tile of a lower level is constrained to stay within the proper quadrant of their respective tiles of higher level.

In a preferred embodiment, a comparison is performed between each distorted tiles of the pyramid and the original image. This allows for decreasing computation at analysis time, and also allows for a certain degree of freedom for each tile allowing them to exhibit their own best match within each scan part of the loop process in order to choose the lowest 21 SSD values.

It should be noted that the search for the best match itself before submission to the enumeration module is an implementation decision that can be removed entirely, whereby the 21 values outcome from every set of morphed version tried on every area of interest (359) (in the range of millions) can be submitted to the enumeration volume to deliver a probability with good quality that the human exists.

### Movement Detection and Analysis

Referring back to FIG. 2, and as discussed above, the image analyzer 310 detects the presence of a human in the images received from the camera 20 along with the position of the human within the image, in accordance with an embodiment. When detecting a human, the image analyzer 310 outputs this info (size and position of the human) to the movement detector 410. The movement detector 410 is adapted to detect the movement of the human based on a change of position of the human in the succession of images, as exemplified in FIGS. 10a to 10d. FIGS. 10a to 10d illustrate examples of images showing a human body in different zones/locations.

In an embodiment, the movement detector 410 may determine the direction of the movement and the zone in which the movement is occurring. For example, the detector 410 may indicate that there is a movement in zone C heading toward zone B. In an embodiment, the movement detector 410 signals the movements to the sequence analyzer 510.

As discussed above, the sequence analyzer 51 detects an intrusion when a predefined succession of events occurs in a specified order. One example of an event may include the detection of a movement within or across one of the zones. Another example may include the disappearance of a human body in one of the zones. A further event may include the appearance of a human body in one of the zones etc.

In one embodiment, the zones may be automatically set by the system, whereby as discussed above the system may be configured to detect an aperture in the monitored area through which people appear and disappear, and define the zones around the aperture using pre-determined criteria. In another embodiment, the user may be able to draw the zones over the image using a graphical interface or the like. For example, the user may draw the zones of interest using a pointing device or a graphic tool and set the succession of events that represent an intrusion.

In a further embodiment, the change in the size of the human body within the image may define an event that may be used in the succession of events defining an intrusion. Needless to say, the use of the change of size of the human body as a criterion to define an event depends on the scenario and the conditions set by the user. For example, if the camera was on the inside of the house then it is the increase in size that should be included in the sequence of events, rather than the decrease because the intruder has to come through the aperture and approach closer toward the camera, thus the size of the human body within the image would increase rather than decrease.

While FIG. 2 illustrates the image analyzer 310, movement detector 410, and sequence analyzer 510 as being different modules, it should also be noted that these modules may be combined together in one module or in different combinations without departing from the scope of the present disclosure.

### Detection of Multiple Humans

The following embodiments describe another type of events which is based on the detection of more than one human in the image simultaneously. The embodiments discussed above with reference to FIGS. 4 and 5, explain the process for detecting one human in the image 340 received from the camera 20 using the image analyzer 310. In the present embodiment, the image analyzer 310 may also be adapted to detect more than one human in the image 340 using the same principles. For example, as discussed in connection with FIGS. 4 & 5, the scanner module 346 divides a binary version of the image 340 into a plurality of areas 359 and performs SSD between each area 359 and the ideal image(s) 345 to calculate the lowest SSD values for each area 359 and the probability that a human exists in the area 359. In the present embodiment, the probability sorting module 348 may be adapted to output for each probability that is higher than the predetermined threshold the position and size associated with this probability, as exemplified in FIG. 11, thus outputting the position and size of different human bodies provided in different areas 359 of the image 340.

The movement detector 410 may keep track of the multiple humans within the same image based on the position of each human body in the stream of images, and the speed (or number of pixel shifts) between the current image and the next/previous one.

In an embodiment, the system may be configured to associate two or more human bodies together and create a dependency of one human body onto the other. Examples of possible criteria for associating human bodies together include one or more of: the size of the human bodies; the presence of the human bodies within a certain distance for a certain time, the direction in which the human bodies are moving etc.

In a further embodiment, the system may be configured to restrict one or more zones to human bodies having certain characteristics, while unrestricting these zones to human bodies having other characteristics. An example of such characteristics may include the size of the human body. For example, the pool may be a restricted zone to the child (small sized human body), but not to the parent. In another unrelated example, the zone may be restricted to two or more adults going in the same direction or heading toward the same place etc.

In a non limiting example of implementation, the system may determine based on the size of human bodies that a child is being accompanied by a parent based on the fact that the small-sized human body is/was within a predetermined distance of the bigger sized human body (which is the typical case of a child walking or standing beside a parent). In a non-limiting example of implementation, the system may be configured so that, the small sized human body depends on the bigger-sized human body within a restricted area e.g. the pool. In the present case, if the two human bodies enter the pool zone, no alarm is triggered (e.g. no intrusion is detected) since the parent is assumed to be in charge of the child and since the pool is not restricted onto the parent. However, if the child enters the pool zone while the parent does not, an alarm is triggered (or an action is performed such as the automated call for help or the like) because the pool zone is restricted to the child when alone. In another scenario, if the child remains in a non-restricted area while the parent enters in the pool, no alarm is triggered because the presence in the pool zone is restricted to the child but not the parent.

### Detection of Different Sizes

It should be noted that the morphing of the ideal image 345 and the pyramidal comparison process which compares different resolutions of the ideal image 345 allow for detecting human bodies of different sizes within the images received from the camera 20 during the scanning process performed in the scanner module 346. The following description describes an example of detecting the different sizes of the human body within the images received from the camera 20.

The present embodiment is performed during the installation phase (when installing the system to monitor a certain area). Upon installing the camera 20 in a specific location and directing it toward the area that is to be monitored, an adult may be asked to stand in the furthest location of the area, as exemplified in FIG. 13a in order to measure the angle α′ that the adult defines within the point of view of the camera 20 from the farthest location. The adult may also be asked to stand in the closest location of area 410 in order to measure the angle α″ that the adult defines within the point of view of the camera 20 from the closest location, as exemplified in FIG. 13b. The angles α′ and α″ define the range (and/or ratio) within which an angle of an adult may vary between the farthest and the closest locations of the area 410. Needless to say, a slight margin may be applied to the angles in order to accommodate for taller or shorter people.

In order to detect small sized human bodies e.g. children or toddlers, an angle β may be used. The angles β′ and β″ (which correspond to α′ and α″, respectively) may either be calculated using the same method as above e.g. by asking a child to stand with the parent or alone in the farthest and closest locations of the area, or may be predetermined using prior experiments.

In an embodiment, the system may also use the position of the bottom part of the detected subject to establish the distance between the detected object and the camera. This allows for differentiating between a child who is near and an adult who is far. In a non-limiting example of implementation, the system detects the angle Ω between a first axis defined by the bottom part of the detected object and the zoom of camera and a second which may be the Y axis (vertical axis) or the X axis (the horizontal axis). For example, as shown in FIG. 12a the angle Ω′ is bigger than the angle Ω″ in FIG. 12b for the same object (the adult) because the detected object in FIG. 12a is further to the camera than in FIG. 12b.

Accordingly, the system may determine the size of objects using rules of perspective. For instance, as discussed above the system determines the size of an object using the angles α and β. Then, using the angle Ω the system may determine the distance between the camera and the detected object to distinguish between a child who is near and an adult who is far even when the adult and the child have the same size on the image due to the different distances between each one of them and the camera, as exemplified in FIG. 12c.

In yet a further embodiment, if the camera is installed over the pool (which is a possible but very rare scenario), it would still be possible to implement the embodiments discussed above by changing the angles and the ratio between them based on the distance between the lens of the camera and the ground. However, in the scenario where the human body is immediately below the camera such that the angle is very low, it would be possible to determine the size of the human body using the step size. For example, by comparing the distance between the legs when the human body walks it would be possible to detect within a given margin whether or not the human body is an adult or a child.

In another embodiment, detection of different sizes is based on inherent morphological size differences between children and adults. For example it is well known that the head to shoulder and head to body ration are higher for children than for adults. These differences may be used by the system to determine whether or not the detected human body is for a child or an adult. For example, when the head to body or head to shoulder is higher than a pre-defined threshold the system may interpret that the human body is a child.

### Pool Example

As discussed above, the user may define the different zones in the monitored area using a graphical tool or the like. However, in a preferred embodiment the zones may be defined during the installation phase by asking an adult and/or a child to define the different zones by walking on the perimeter of each zone. This embodiment allows the system to detect each zone and obtain/measure the size of the human body at each point of the zone perimeter for a more accurate processing.

FIGS. 13a to 13c illustrate an example of detecting multiple humans and associating them together. As shown in FIG. 13a, the system detects two human bodies 370 and 372 having different sizes and walking beside each other. In a non-limiting example of implementation, the system may associate the bodies 370 and 372 with each other based on the difference in size and/or the presence within a predetermined distance of each other for a certain period.

In the present example, assume that the zone 374 is a pool and the zone 376 is the first area surrounding the pool, and that the zones 374 and 376 are restricted to the child 370 but not to the parent 372. Zone 378 is a zone where the child is not authorized alone but is authorized if an adult is detected within the monitored area but not necessarily with the child. Zone 380 is the farthest area where an adult can be and still be able to deliver help in a timely manner.

In an embodiment, the child 370 may be allowed in the pool 374 if accompanied by the parent 372, as shown in FIG. 13b based on the dependency of the child 370 to the parent 372. Accordingly, in the image shown in FIG. 13b the system does not trigger an alarm (indicative of a breach of security) because the child 370 depends on the parent 372 and because the parent 372 is allowed in the pool 374. However, if the child goes in the restricted zone 374 without the parent as exemplified in FIG. 13c, the system will trigger an alarm (or perform an predefined action) flagging the breach of security.

In another embodiment, the system may be configured to apply one or more of the following:
If the child is in zone 376 without the parent, an injection may be issued e.g. an audible warning, asking the child to leave the area. If the movement of the child is towards the zone 374 and not toward the zone 378 then a call for help may be triggered by the system based on the presence or absence of an adult in the vicinity.
If an adult 372 is detected in zone 376 the child can be allowed in the zone 376. If an adult is detected in area 380 then child is only allowed in zone 378 as the adult is considered to be too far to arrive at the pool in time to prevent the child from entering the pool alone.
If an adult is detected in zone 380 and a child is detected in zone 376, a warning may be issued as a call for user attention. However, if the child goes in the pool an alarm state may be activated indicating the highest degree of emergency and causing the system to produce a very loud sound and/or perform an immediate call for assistance or the like.
If an adult & a child move simultaneously from zone 378 to 374 then, even if adult leaves the zone 374 towards 378 or 380 no alarm is triggered as it is presumed that the adult acts in a sensible manner and did not leave the child un-intentionally. Hence no alarm is triggered even if child is in zone 374 alone.
In an enhanced embodiment, different combinations of activities may be monitored to trigger an alarm or call for help. For example, if the system detects a child in the pool, and then the child disappears, the system may interpret this series of events to indicate that he child is drowning. In another scenario, if the child comes to the pool alone without a parent, the system may also interpret this as a breach of security and activate an alarm, or perform a pre-defined action. In another embodiment, if the system detects that an adults disappeared in the pool for more than a minute (or a pre-determined period) an alarm may be activated.

In an embodiment, system may include or be operably connected to a speech synthesizer for asking the adult 372 to enter the zone 376 to void/deactivate the alarm state. In another embodiment, the system may include a gesture detector such as that described in U.S. patent application Ser. No. 13/837,689 filed on Mar. 15, 2013 and entitled “Authenticating A User Using Hand Gesture” for recognizing a sign/gesture from the adult 372 to authorize the child 374 to exist in a restricted zone.

Accordingly, the system provides the user with a number of events that may be detected by the system. The user may define one or more succession of events and assign one or more actions (to be performed by the system) with each succession of events. For example, if the child approaches the pool alone, the system may trigger an audible warning. By contrast, if the child enters in the pool alone the system may automatically contact security.

In an embodiment, detection of the intrusion may be done using the probabilistic approach described above in connection with FIGS. 4 to 9. Whereby, instead of feeding the system with No samples representing images that do not include the meta-subject and Yes samples which only include the meta-subject, the system may be fed with samples indicating either a normal behavior or an abnormal behavior. In FIGS. 4 to 9, the sample represents an image. However, in the present case the sample represents the sequence of events/movements between the different zones in a clip including several frames. Furthermore, the dimensions in the multidimensional space represent the zones and not the SSD values. In a non-limiting example, if the area that is monitored includes six zones, the multidimensional space may include six dimensions. An example is provided with respect to FIGS. 14a to 14f.

FIGS. 14a to 14F are images/frames of an exemplary clip defining a normal behavior. In the present example, assuming that the camera is installed inside a room to monitor the behavior of people. In the example of FIGS. 14a to 14f, the sample that is classified in the multidimensional space may include the following sequence of events/movements: movement from Zone C to Zone B, movement from Zone B to Zone A, movement from Zone A to Aperture, movement from aperture to zone D, and movement from zone D to aperture. This sequence of movements represents the typical scenario of someone walking from one end of the room to the other end and returning which is considered a normal behavior.

FIGS. 15a to 15f are images/frames of an exemplary clip defining an abnormal behavior in the same environment of FIGS. 14a to 14f. In the example of FIGS. 15a to 15f, the sample that is classified in the multidimensional space may include the following sequence of events/movements: appearance in the aperture, movement from aperture to zone D, return from zone D to aperture, movement from aperture to zone A, return from zone A to aperture, movement from aperture to Zone A again.

As discussed above, images which include humans tend to cluster when they are classified in the multidimensional space, while images that include things other than a human disperse. The same applies in the case of clips whereby normal behaviors tend to have a certain trend, and will therefore cluster. By contrast, abnormal behaviors may be very random and different, and for this reason they will disperse. FIG. 16 illustrates a hypothetical example of a multidimensional space for classifying the samples and determining the probability that a given sample represents a normal or an abnormal behavior. Accordingly, the system may monitor the behavior so that the mere fact that an unusual sequence of movements is happening such that too much back and forth between one zone and the other may be sufficient to be flagged as suspicious.

Needless to say, the embodiments discussed above may also be applied with the present embodiment, such as generating some sort of signal e.g. an audio signal using a speaker or a visual signal on a display, asking the detected person to explain what they are doing verbally to record the message using a microphone and storing the audio message and/or sending it to a third party for verification. The system may also ask the user to perform a gesture in order to deactivate the alarm.

One of the main advantages of this approach is that it is easier to implement when the number of zones and people within the zones increases, and so is the amount of programming needed for configuring the system. As discussed above, this approach is of a probabilistic nature whereby, the probability of a sample being determined as representing a normal or abnormal behavior depends on the number of samples around the given sample, as discussed above.

FIG. 17 is a flowchart of a vision based computer-implemented method for detecting a breach of security in a monitored location. The method 400 begins at step 410 by storing a succession of events defining the breach of security and an action to be performed in response to detecting the breach of security. Step 420 comprises receiving a stream of images of said location from an image capturing device. Step 430 comprises defining at least a first zone and a second zone within said images. Step 440 comprises detecting a first sequence of events matching the predetermined sequence in said images including: detecting a first event in the first zone; and detecting a second event in the second zone; wherein at least one of the first event and the second event represent detection of a first human body in a corresponding zone. Step 450 comprises performing the action associated with the breach of security, in response to detecting the first sequence.

FIG. 18 is a flowchart of another vision based computer-implemented method for detecting a breach of security in a monitored location. The method 460 begins at step 462 by storing a succession of events defining the breach of security and an action to be performed in response to detecting the breach of security, said succession of events comprising two or more events and a predetermined sequence in which said events are performed. Step 464 comprises receiving a stream of images of said location from an image capturing device. Step 466 comprises defining at least a first zone defining the body of water and a second zone adjacent the body of water within said images. Step 468 comprises detecting a first sequence of events matching the predetermined sequence in said images, including: detecting a first event in said location; detecting a second event in said location; wherein at least one of the first event and the second event represents detection of a child alone in said location. Step 470 comprises performing the action associated with the breach of security, in response to detecting the first sequence.

FIG. 21 is a flowchart of another vision based computer-implemented method for detecting a breach of security in a body of water. The method 472 begins at step 474 by storing a succession of events defining the breach of security and an action to be performed in response to detecting the breach of security, said succession of events comprising two or more events and a predetermined sequence in which said events are performed. Step 476 comprises receiving a stream of images of said location from an image capturing device. Step 478 comprises defining at least a first zone defining the body of water and a second zone adjacent the body of water within said images. Step 480 comprises detecting a first sequence of events matching the predetermined sequence in said images, including: detecting a first event in said location; detecting a second event in said location; wherein at least one of the first event and the second event represents detection of a human body in said first zone.

FIG. 20 for detecting a breach of security in a monitored location. The method 484 begins at step 486 by storing a succession of events defining the breach of security and an action to be performed in response to detecting the breach of security, said succession of events comprising two or more events and a predetermined sequence in which said events are performed. Step 488 comprises receiving a stream of images of said location from an image capturing device. Step 490 comprises defining at least a first zone, a second zone adjacent the first zone, a third zone adjacent the second zone and an aperture through which people may enter or leave the location within said images, wherein the aperture is adjacent the first zone such the first zone separates between the aperture and the second zone. Step 492 comprises detecting a first sequence of events matching the predetermined sequence in said images, the first sequence including the following events: at T0 detecting appearance of a first human body in the aperture; at T1 detecting the first human body in the first zone and a second human body in the aperture; at T2 detecting the first human body in the second zone and the second human body in the first zone; at T4 detecting the first human body in the third zone and one of: disappearance of the first human body from the second zone or disappearance of the second human body from the first zone. Step 494 comprises performing the action associated with the breach of security, in response to detecting the first sequence.

### Hardware and Operating Environment

FIG. 21 illustrates an exemplary diagram of a suitable computing operating environment in which embodiments of the invention may be practiced. The following description is associated with FIG. 21 and is intended to provide a brief, general description of suitable computer hardware and a suitable computing environment in conjunction with which the embodiments may be implemented. Not all the components are required to practice the embodiments, and variations in the arrangement and type of the components may be made without departing from the spirit or scope of the embodiments.

Although not required, the embodiments are described in the general context of computer-executable instructions, such as program modules, being executed by a computer, such as a personal computer, a hand-held or palm-size computer, Smartphone, or an embedded system such as a computer in a consumer device or specialized industrial controller. Generally, program modules include routines, programs, objects, components, data structures, etc., that perform particular tasks or implement particular abstract data types.

Moreover, those skilled in the art will appreciate that the embodiments may be practiced with other computer system configurations, including hand-held devices, multiprocessor systems, microprocessor-based or programmable consumer electronics, network PCS, minicomputers, mainframe computers, cellular telephones, smart phones, display pagers, radio frequency (RF) devices, infrared (IR) devices, Personal Digital Assistants (PDAs), laptop computers, wearable computers, tablet computers, a device of the IPOD or IPAD family of devices manufactured by Apple Computer, integrated devices combining one or more of the preceding devices, or any other computing device capable of performing the methods and systems described herein. The embodiments may also be practiced in distributed computing environments where tasks are performed by remote processing devices that are linked through a communications network. In a distributed computing environment, program modules may be located in both local and remote memory storage devices.

The exemplary hardware and operating environment of FIG. 21 includes a general purpose computing device in the form of a computer 720, including a processing unit 721, a system memory 722, and a system bus 723 that operatively couples various system components including the system memory to the processing unit 721. There may be only one or there may be more than one processing unit 721, such that the processor of computer 720 comprises a single central-processing unit (CPU), or a plurality of processing units, commonly referred to as a parallel processing environment. The computer 720 may be a conventional computer, a distributed computer, or any other type of computer; the embodiments are not so limited.

The system bus 723 may be any of several types of bus structures including a memory bus or memory controller, a peripheral bus, and a local bus using any of a variety of bus architectures. The system memory may also be referred to as simply the memory, and includes read only memory (ROM) 724 and random access memory (RAM) 725. A basic input/output system (BIOS) 726, containing the basic routines that help to transfer information between elements within the computer 720, such as during start-up, is stored in ROM 724. In one embodiment of the invention, the computer 720 further includes a hard disk drive 727 for reading from and writing to a hard disk, not shown, a magnetic disk drive 728 for reading from or writing to a removable magnetic disk 729, and an optical disk drive 730 for reading from or writing to a removable optical disk 731 such as a CD ROM or other optical media. In alternative embodiments of the invention, the functionality provided by the hard disk drive 727, magnetic disk 729 and optical disk drive 730 is emulated using volatile or non-volatile RAM in order to conserve power and reduce the size of the system. In these alternative embodiments, the RAM may be fixed in the computer system, or it may be a removable RAM device, such as a Compact Flash memory card.

In an embodiment of the invention, the hard disk drive 727, magnetic disk drive 728, and optical disk drive 730 are connected to the system bus 723 by a hard disk drive interface 732, a magnetic disk drive interface 733, and an optical disk drive interface 734, respectively. The drives and their associated computer-readable media provide nonvolatile storage of computer-readable instructions, data structures, program modules and other data for the computer 720. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 729, optical disk 731, ROM 724, or RAM 725, including an operating system 735, one or more application programs 736, other program modules 737, and program data 738. A user may enter commands and information into the personal computer 720 through input devices such as a keyboard 740 and pointing device 742. Other input devices (not shown) may include a microphone, joystick, game pad, satellite dish, scanner, touch sensitive pad, or the like. These and other input devices are often connected to the processing unit 721 through a serial port interface 746 that is coupled to the system bus, but may be connected by other interfaces, such as a parallel port, game port, or a universal serial bus (USB). In addition, input to the system may be provided by a microphone to receive audio input.

A monitor 747 or other type of display device is also connected to the system bus 723 via an interface, such as a video adapter 748. In one embodiment of the invention, the monitor comprises a Liquid Crystal Display (LCD). In addition to the monitor, computers typically include other peripheral output devices (not shown), such as speakers and printers. The monitor may include a touch sensitive surface which allows the user to interface with the computer by pressing on or touching the surface.

The computer 720 may operate in a networked environment using logical connections to one or more remote computers, such as a remote computer 749. These logical connections are achieved by a communication device coupled to or a part of the computer 720; the embodiments is not limited to a particular type of communications device. The remote computer 749 may be another computer, a server, a router, a network PC, a client, a peer device or other common network node, and typically includes many or all of the elements described above relative to the computer 720, although only a memory storage device 750 has been illustrated in FIG. 7. The logical connections depicted in FIG. 7 include a local-area network (LAN) 751 and a wide-area network (WAN) 752. Such networking environments are commonplace in offices, enterprise-wide computer networks, intranets and the Internet.

When used in a LAN-networking environment, the computer 720 is connected to the local network 751 through a network interface or adapter 753, which is one type of communications device. When used in a WAN-networking environment, the computer 720 typically includes a modem 754, a type of communications device, or any other type of communications device for establishing communications over the wide area network 752, such as the Internet. The modem 754, which may be internal or external, is connected to the system bus 723 via the serial port interface 746. In a networked environment, program modules depicted relative to the personal computer 720, or portions thereof, may be stored in the remote memory storage device. It is appreciated that the network connections shown are exemplary and other means of and communications devices for establishing a communications link between the computers may be used.

The hardware and operating environment in conjunction with which embodiments of the invention may be practiced has been described. The computer in conjunction with which embodiments of the invention may be practiced may be a conventional computer a hand-held or palm-size computer, a computer in an embedded system, a distributed computer, or any other type of computer; the invention is not so limited. Such a computer typically includes one or more processing units as its processor, and a computer-readable medium such as a memory. The computer may also include a communications device such as a network adapter or a modem, so that it is able to communicatively couple other computers.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A vision based computer-implemented method for detecting a breach of security in a monitored location, the method comprising:
storing a succession of events defining the breach of security and an action to be performed in response to detecting the breach of security, said succession of events comprising two or more events and a predetermined sequence in which said events are performed;
receiving a stream of images of said location from an image capturing device;
defining at least a first zone and a second zone within said images;
detecting a first sequence of events matching the predetermined sequence in said images, including:
detecting a first event in the first zone; and
detecting a second event in the second zone;
wherein at least one of the first event and the second event represent detection of a source of activity in a corresponding zone;
performing the action associated with the breach of security, in response to detecting the first sequence.

2. The method of claim 1, wherein the first event represents detection of the first source of activity in the first zone and the second event represents detection of the first source of activity in the second zone, wherein the first sequence comprises detecting the first event prior to detecting the second event.

3. The method of claim 1, wherein the first event represents detection of the first source of activity in the first zone and the second event represents detection of the first source of activity in the second zone, wherein the first sequence comprises detecting the second event prior to detecting the first event.

4. The method of claim 3, wherein the first sequence comprises detecting a third event representing disappearance of the first source of activity in the first zone after detecting the first event and the second event.

5. The method of claim 1, wherein the first event represents detection of the first source of activity in the first zone, and the second event represents absence of the first source of activity from the second zone, wherein the first sequence comprises detecting the second event prior to detecting the first event.

6. The method of claim 1, wherein the first zone defines an aperture through which humans may pass, and wherein the first event represents absence of a first human body from the first zone, and the second event represents detection of the first human body in the second zone, the method further comprising:
defining a third zone within the images such that the second zone is located between the first zone and the third zone; and
detecting a third event representing absence of a first human body from the third zone;
wherein the first sequence comprises detecting the second event after detecting the first event and the third event.

7. The method of claim 1, wherein the first zone defines an aperture through which humans may pass, and wherein the first event represents detection of a first human body in the first zone, and the second event represents detection of the first human body in the second zone, the method further comprising:
defining a third zone within the images such that the second zone is located between the first zone and the third zone; and
detecting a third event representing absence of a first human body from the third zone;
wherein the first sequence comprises detecting the second event or the first event after detecting the third event.

8. The method of claim 1, wherein the first sequence comprises detecting a third event representing detection of a change in size of the first human body.

9. The method of claim 1, further comprising:
detecting a second human body other than the first human body; and
associating the first human body with the second human body based on one or more of:
a difference in size between the first human body and the second human body; and
a presence of the first human body and the second human body within a first predetermined distance for a predetermined period.

10. The method of claim 9, wherein the first area is restricted onto the first human body when the first human body is alone, wherein the first event represents detection of the first human body in the first area, and the second event represents absence of the second human body from the monitored location.

11. The method of claim 9, wherein the first area is adjacent the second area and the first area is restricted onto the first human body, wherein the first event represents detection of the first human body in the second area at a third distance from the first area, and the second event comprises detection of the second human body at a fourth distance that is beyond a permitted distance, wherein the permitted distance is calculated based on the third distance and the direction of movement of the first human body.

12. The method of claim 11, wherein the action performed in response to detecting the breach of security comprises activating an audible alarm.

13. The method of claim 12, further comprising:
detecting a predefined gesture performed by the second human body after activating the audible alarm;
deactivating the audible alarm in response to detecting the predefined gesture.

14. The method of claim 1, wherein detecting the first human body comprises:
scanning images of the location in search for the human body using a pre-loaded image of the same or another human body.

15. The method of claim 14, wherein scanning comprises:
dividing a given image of the stream into a plurality of areas such that adjacent area have overlapping pixels, and
comparing each one of the plurality of areas to the pre-loaded image.

16. The method of claim 15, further comprising transforming the image of the location and the pre-loaded image to a binary format, wherein the comparing comprises performing a sum of square difference (SSD) between the pre-loaded image and each one of the plurality of areas.

17. The method of claim 16, further comprising building a multidimensional space of samples including match samples (YES samples) and no-match samples (NO samples), the building comprising:
obtaining a plurality of sample images from an image bank, said sample images consisting of images that only show a human body and images that do not show a human body;
transforming each sample image into a binary format;
dividing each sample image into a plurality of areas;
providing different versions of the preloaded image of the human body in the binary format, each version having a different resolution, and dividing each version into one or more tiles, thus producing a number m of tiles from all the different versions;
performing the SSD between each sample image and each tile, to produce a first set of SSD values including m SSD values;
classifying each first set of SSD values in an m-dimensional space; wherein each first set of SSD values associated with a sample image showing only a human body is classified as a YES sample, and each first set of SSD values associated with a sample image not showing a human body is classified as a NO sample.

18. The method of claim 17, further comprising:
performing the SSD between each area of the given image and each tile of the pre-loaded image, to produce a second set of SSD values including m SSD values for each area;
classifying said second set of SSD values as a sample point in the m-dimensional space;
counting a number of YES samples and a number of NO samples within a predefined volume around the sample point associated with a given area;
calculating a third ratio of Yes samples versus No samples within the predefined volume; and
dividing the third ratio by a fourth ratio representing the number of Yes samples versus No samples in the entire m-dimensional space, thus producing an area-probability indicative of the presence of the human body in the given area.

19. The method of claim 18 further comprising:
morphing the pre-loaded image in a plurality of dimensions to produce morphed versions of the pre-loaded image, and
performing SSD between each morphed version of the pre-loaded image and each area to obtain a plurality of second sets SSD values;
outputting the second SSD set having the lowest values for classification in the m-dimensional space.

20. The method of claim 18, further comprising:
if the image-probability is greater than a predetermined threshold, outputting a position of the human body in the given image.

21. The method of claim 20, further comprising outputting a size of the human body in the given image.

22. The method of claim 18, further comprising outputting the position and size of more than one probability associated with different areas of the given image, thus detecting more than one human body in the given image.

23. The method of claim 15 further comprising:
comparing each one of the plurality of areas to a plurality of pre-loaded images, each preloaded image representing a different position of the human body.

24. A vision based computer-implemented method for detecting a breach of security in a location including a body of water, the method comprising:
storing a succession of events defining the breach of security and an action to be performed in response to detecting the breach of security, said succession of events comprising two or more events and a predetermined sequence in which said events are performed;
receiving a stream of images of said location from an image capturing device;
defining at least a first zone defining the body of water and a second zone adjacent the body of water within said images;
detecting a first sequence of events matching the predetermined sequence in said images, including:
detecting a first event in said location;
detecting a second event in said location;
wherein at least one of the first event and the second event represents detection of a child alone in said location;
performing the action associated with the breach of security, in response to detecting the first sequence.

25. The method of claim 24, wherein detection of the child comprises:
detecting a first human body;
detecting a size of the first human body; wherein detecting the size comprises:
detecting a first angle between a first axis between a lens of the image capturing device and a head of the first human body and a second axis between the lens of the image capturing device and a foot of the first human body;
estimating a distance between the image capturing device and the first human body using a second angle between the second axis and a vertical axis;
determining the size based on the first angle and the second angle.

26. The method of claim 25, wherein detection of the child alone comprises detection of the child beyond a first pre-determined distance from a nearest adult.

27. The method of claim 26, further comprising calculating the pre-determined distance as a function of a second distance between the child and the body of water, such that the child can walk the second distance before the adult reaches the child.

28. The method of claim 25, wherein the first event represents detection of the child alone in the second zone and the second event represents detection of the child alone in the first zone, wherein the first sequence comprises detecting the first event prior to detecting the second event.

29. The method of claim 25, wherein the first event represents detection of the child alone in the first zone and the second event represents disappearance of the child from the first zone, wherein the first sequence comprises detecting the first event prior to detecting the second event.

30. The method of claim 26, wherein the action performed in response to detecting the breach of security comprises activating an alarm.

31. The method of claim 30, further comprising:
detecting a predefined gesture performed by the adult after activating the alarm;
deactivating the alarm in response to detecting the predefined gesture.

32. The method of claim 24, wherein detection of the child is based on morphological size differences between adults and children.

33. The method of claim 32, further comprising:
calculating at least one of: head to shoulder ratio and head to body ratio;
comparing said ratio to a predefined threshold.

34. A vision based computer-implemented method for detecting a breach of security in a location including a body of water, the method comprising:
storing a succession of events defining the breach of security and an action to be performed in response to detecting the breach of security, said succession of events comprising two or more events and a predetermined sequence in which said events are performed;
receiving a stream of images of said location from an image capturing device;
defining at least a first zone defining the body of water and a second zone adjacent the body of water within said images;
detecting a first sequence of events matching the predetermined sequence in said images, including:
detecting a first event in said location;
detecting a second event in said location;
wherein at least one of the first event and the second event represents detection of a human body in said first zone;
performing the action associated with the breach of security, in response to detecting the first sequence.

35. The method of claim 34 further comprising detecting that the human body is a child based on a size of the human body.

36. The method of claim 35, wherein detecting the size comprises:
detecting a first angle between a first axis between a lens of the image capturing device and a head of the human body and a second axis between the lens of the image capturing device and a foot of the human body;
estimating a distance between the image capturing device and the human body using a second angle between the second axis and a vertical axis;
determining the size based on the first angle and the second angle.

37. A vision based computer-implemented method for detecting a breach of security in a monitored location, the method comprising:
storing a succession of events defining the breach of security and an action to be performed in response to detecting the breach of security, said succession of events comprising two or more events and a predetermined sequence in which said events are performed;
receiving a stream of images of said location from an image capturing device;
defining at least a first zone, a second zone adjacent the first zone, a third zone adjacent the second zone and an aperture through which people may enter or leave the location within said images, wherein the aperture is adjacent the first zone such the first zone separates between the aperture and the second zone;
detecting a first sequence of events matching the predetermined sequence in said images, the first sequence including the following events:
at T0 detecting appearance of a first human body in the aperture;
at T1 detecting the first human body in the first zone and a second human body in the aperture;
at T2 detecting the first human body in the second zone and the second human body in the first zone;
at T4 detecting the first human body in the third zone and one of: disappearance of the first human body from the second zone or disappearance of the second human body from the first zone;
performing the action associated with the breach of security, in response to detecting the first sequence.

38. A computing device having access to computer readable instructions for implementing the method of claim 1.

39. A computing device having access to computer readable instructions for implementing the method of claim 24.
